(19) United States
(12) Patent Application Publication
(10) Pub. No.: US 2016/0324149 A1
(43) Pub. Date: Nov. 10, 2016

(54) ADJUVANTS FOR PLANT GROWTH REGULATORS

(71) Applicant: VERDESIAN LIFE SCINCES, LLC, Cary, NC (US)

(72) Inventor: John Larry Sanders, Leawood, KS (US)

(73) Assignee: Verdesian Life Sciences, LLC, Cary, NC (US)

(21) Appl. No.: 15/110,062

(22) PCT Filed: Jan. 28, 2015
(86) PCT No.: PCT/US15/13345

§ 371 Date: Jul. 6, 2016

Related U.S. Application Data
(60) Provisional application No. 62/001,362, filed on May 21, 2014.
(60) Provisional application No. 61/933,019, filed on Jan. 29, 2014.

(30) Foreign Application Priority Data
Jan. 28, 2015 (US) PCT/US2015/013345

(51) Int. Cl. A01N 25/30; A01N 43/90; A01N 45/00; C08F 222/02; C05G 3/06; C05G 3/02; C05G 3/00; C08F 222/06; A01N 43/38; C05B 7/00

(52) U.S. Cl. CPC A01N 25/30; A01N 43/38; A01N 43/90; A01N 45/00; C05B 7/00; C05G 3/06; C05G 3/02; C05G 3/0076; C08F 222/06; C08F 222/02

(57) ABSTRACT

Plant growth regulator compositions comprise an aqueous mixture of one or more plant growth regulators and one or more polyanionic polymers. The polymers contain at least about 80 mol percent of repeat units bearing at least one anionic functional group, the plant growth regulator being present at a level of up to about 6000 ppm. Preferably, the polymers contain respective amounts of maleic and itaconic repeat units.

### CROSS-REFERENCE TO RELATED APPLICATIONS

This application claims the benefit of two provisional applications, Ser. No. 62/001,362 filed May 21, 2014, and Ser. No. 61/933,019 filed Jan. 29, 2014, both of which are incorporated herein by reference in their entireties.

### BACKGROUND OF THE INVENTION

1. Field of the Invention

The present invention is broadly concerned with improved compositions for plant growth regulation comprising at least one polyanionic polymer in combination with one or more plant growth regulators. in preferred forms, the polyanionic polymer comprises a copolymer (e.g., a polymer containing two or more different repeat units) containing respective quantities of maleic and itaconic repeat units. The compositions of the invention synergistically increase crop yields.

2. Description of the Prior Art

The use of plant growth regulators in agricultural production within the United States began in the 1930s. The first discovery and use of plant growth regulators was with acetylene and ethylene, which enhanced flower production in pineapple. Subsequently, use of plant growth regulators has grown exponentially to become a major component of agricultural commodity production. Plant growth regulators fall into several major classes, including antiauxins, auxins, cytokinins, defoliants, ethylene inhibitors, ethylene releasers, gametocides, gibberellins, growth inhibitors, growth retardants, growth stimulators, and unclassified growth regulators. Many commercial plant growth regulator products are available for specific plant uses.

Despite the widespread use of plant growth regulators, there is a need for adjuvants which can enhance the desired effectiveness of otherwise known regulators.

### SUMMARY OF THE INVENTION

The present invention addresses this need and provides compositions broadly comprising at least one plant growth regulator in combination with a polyanionic polymer. Advantageously, the polymer fractions of the compositions serve to synergistically increase the desired plant growth regulations afforded by the plant growth regulators in question. That is, the polymer gives an increase in desired plant growth regulation greater than that which is obtained through the use of the plant growth regulator alone and the polymer alone.

Generally speaking, the plant growth regulators useful in the invention are selected from the group consisting of antiauxins, auxins, cytokinins, defoliants, ethylene inhibitors, ethylene releasers, gametocides, gibberellins, growth inhibitors, growth retardants, growth stimulators, signaling agents, unclassified growth regulators, and mixtures thereof; in many instances it is desirable to use a plurality of different plant growth regulators.

Although a number of polymers may be used in the context of the invention, it is particularly preferred that polymers including respective amounts of maleic and itaconic repeat units are employed. In certain embodiments, such polymers normally contain at least about 85% by weight of maleic and itaconic repeat units, more preferably at least about 93% by weight thereof, and most preferably the polymers consist essentially of maleic and itaconic repeat units. In other embodiments, sulfonate repeat units may also form a part of the polymers.

The compositions of the invention may be in liquid form, particularly as aqueous dispersions containing the plant growth regulator and polymer, and may also include liquid fertilizers and micronutrients. The liquids may be initially formulated as concentrates, which are then diluted to give use compositions.

The compositions of the invention may be used an applied in a variety of ways. For example, seeds may be coated with the compositions prior to planting thereof, or the compositions may be applied to growing plans or the soil adjacent such plants. Conventional application methods such as dipping, drenching, and spraying may be used in greenhouse contexts, whereas the compositions may be applied using broadcast techniques, or in-furrow or sideband applications in the case of field crops.

The invention also provides seed products comprising a plant seed in at least localized contact, or in direct contact, with the growth regulator compositions hereof. “Localized contact” refers to a situation where a plant growth regulator composition is in proximity to a seed sufficient to provide the beneficial effects of the invention, even though the seed is not in direct or intimate contact with the composition.

### DETAILED DESCRIPTION OF THE PREFERRED EMBODIMENTS

As noted above, the present invention is directed to compositions including one or more plant growth regulators and one or more polymeric adjuvants for the regulators. As used herein, “plant growth regulators” are substances or mixtures of substances applied to seeds, growing plants, and/or the soil adjacent seeds or plants, and which, by virtue of the nature of the substance or mixture of substances, the amount(s) thereof used, and/or the timing of the uses thereof, are operable for accelerating or retarding the rate of growth or maturation or for otherwise altering the behavior of seeds, plants, or the produce thereof (e.g., seed germination, root growth, development processes, plant growth, maturation, and senescence, fruit set, and fruit drop) through physiological action(s). “Plant growth regulators” do not include substances or mixtures of substances substantially serving as plant nutrients, micronutrients, nutritional chemicals, plant innoculants, desiccants, biocides, pesticides, herbicides, or soil amendments. For example, 2,4-D in certain quantities and methods of use operates as a plant growth regulator, but, in other quantities and methods, serves as a herbicide. The present invention does not embrace these latter quantities and methods.

The plant growth regulators of the invention may include hormones naturally produced by plants, specialized synthetic chemicals, or mixtures thereof.

The polymeric adjuvants useful in the invention are anionic in character, and preferably include carboxylate repeat units, such as maleic and itaconic repeat units. The plant growth regulators and polymeric adjuvants are described individually below.

### Plant Growth Regulators

The invention embraces all types of plant growth regulators of all known classes. The principal plant growth regulator classifications and typical regulators of each class are set forth below, and further details about these regulators can be found at http://www.alanwood.net/pesticides/class_plant_growth_regulators.html, which is incorporated by reference herein in its entirety.
antiauxins: clofibric acid, 2,3,5-tri-iodobenzoic acid;
auxins: 4-CPA, 2,4-D, 2,4-DB, 2,4-DEP, dichlorprop, fenoprop, IAA, IBA, naphthaleneacetamide, α-naphthaleneacetic acids, 1-naphthol, naphthoxyacetic acids, potassium naphthenate, sodium naphthenate, 2,4,5-T;
cytokinins: 2iP, benzyladenine, 4-hydroxyphenethyl alcohol, kinetin, zeatin
defoliants: calcium cyanamide, dimethipin, endothal, ethephon, merphos, metoxuron, pentachlorophenol, thidiazuron, tribufos;
ethylene inhibitors: aviglycine, 1-methylcyclopropene;
ethylene releasers: ACC, etacelasil, ethephon, glyoxime;
gametocides: fenridazon, maleic hydrazide;
gibberellins: gibberellins, gibberellic acid;
growth inhibitors: abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, tiaojiean, 2,3,5-tri-iodobenzoic acid: morphactins (chlorfluren, chlorflurenol, dichlorflurenol, flurenol);
growth retardants: chlormequat, daminozide, flurprimidol, mefluidide, paclobutrazol, tetcyclacis, uniconazole;
growth stimulators: brassinolide, brassinolide-ethyl, DCPTA, forchlorfenuron, gamma-aminobutyric acid, hymexazol, prosuler, pyripropanol, triacontanol;
signaling agents: Ca²⁺, inositol phospholipids, G-proteins, cyclic nucleotides, protein kinases, protein phosphatases, sodium glutamate;
unclassified plant growth regulators: bachmedesh, benzofluor, buminafos, carvone, choline chloride, ciobutide, clofencet, cloxyfonac, cyanamide, cyclanilide, cycloheximide, cyprosulfamide, epocholeone, ethychlozate, ethylene, fuphenthiourea, furalane, heptopargil, holosulf, inabenfide, karetazan, lead arsenate, methasulfocarb, prohexadione, pydanon, sintofen, triapenthenol, trinexapac.

### The Polyanionic Polymers

Generally speaking, the polymers of the invention should have a molecular weight of about 500-5,000,000, more preferably from about 1500-50,000, and contain at least three and preferably more repeat units per molecule (preferably from about 5-1000, and more preferably from about 10-500). Moreover, the partial or complete salts of the polymers should be water dispersible and preferably water soluble, i.e., they should be dispersible or soluble in pure water to a level of at least about 5% w/w at room temperature with mild agitation.

Advantageously, at least about 50% (by mole) of repeat units contain at least 1 carboxylate group. These polymers also are typically capable of forming stable solutions in pure water up to at least about 20% w/w solids at room temperature.

To summarize, the preferred polymers of the invention have the following characteristics:
The polymers should be dispersible and more preferably fully soluble in water to the extent indicated above.
The polymers should have a significant number of repeat units bearing anionic functional groups, preferably such anionic repeat units should be present at a level of at least about 80 mole percent, more preferably at least about 90 mole percent, still more preferably at least about 96 mole percent; most preferably the polymers are essentially free of non-anionic repeat units.
The polymers are stable thermally and chemically for convenient use.
The polymers should be essentially free of ester groups, i.e., no more than about 5 mole percent thereof, and most preferably no more than about 1 mole percent.
The polymers should have only a minimum number of amide-containing repeat units, preferably no more than about 10 mole percent thereof, and more preferably no more than about 5 mole percent.
The polymers should have only a minimum number of monocarboxylate repeat units, preferably no more than about 10 mole percent thereof, and more preferably no more than about 5 mole percent. Rather, the preferred polymers should have at least about 90 mole percent dicarboxylate repeat units.
The polymers may be in free acid form or may exist as partial or complete salts. Such salts are readily formed by reacting the free acid polymers with an appropriate salt-forming cation.
The preferred polymers are generally in aqueous dispersion or solution and have from about 10-90% by weight polymer therein, more preferably from about 30-70% by weight polymer, and still more preferably from about 35-50% by weight polymer, based upon the total weight of the polymer dispersion or solution taken as 100% by weight. The pH of these aqueous polymers is usually acidic, ranging from about 0.5-6.5, more preferably from about 1-4.

The ensuing detailed description of preferred polymers makes use of the art-accepted term “repeat units” to identify the moieties in the polymers. As used herein, “repeat unit” refers to chemically converted forms (including isomers and enantiomers) of initially chemically complete monomer molecules, where such repeat units are created during polymerization reactions, with the repeat units bonding with other repeat units to form a polymer chain. Thus, a type B monomer will be converted to a type B repeat unit, and type C and type G monomers will be converted type C and G repeat units, respectively. For example, the type B maleic acid monomer will be chemically converted owing to polymerization conditions to the corresponding type B maleic acid repeat unit, as follows:

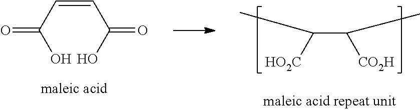

Different monomers within a given polymerization mixture are converted to corresponding repeat units, which bond to each other in various ways depending upon the nature of the repeat groups and the polymerization reaction conditions, to create the final polymer chain, apart from end groups.

In carrying out the invention, it has been determined that certain specific families or classes of polymers are particularly suitable. These are described below as “Class I,” “Class IA,” and “Class II” polymers. Of course, mixtures of these polymer classes are also contemplated.

### Class I Polymers

The Class I polyanionic polymers of the present invention are at least tetrapolymers, i.e., they are composed of at least four different repeat units individually and independently selected from the group consisting of type B, type C, and type G repeat units, and mixtures thereof, described in detail below. However, the Class I polymers comprehend polymers having more than four distinct repeat units, with the excess repeat units being selected from the group consisting of type B, type C, and type G repeat units, and mixtures thereof, as well as other monomers or repeat units not being type B, C, or G repeat units.

Preferred Class I polymers contain at least one repeat unit from each of the B, C, and G types, one other repeat unit selected from the group consisting of type B, type C, and type G repeat units, and optionally other repeat units not selected from type B, type C, and type G repeat units. Particularly preferred polymers comprise a single type B repeat unit, a single type C repeat unit, and two different type G repeat units, or two different type B repeat units, a single type C repeat unit, and one or more different type G repeat units.

However constituted, preferred Class I polymers contain at least about 90 mole percent (more preferably at least about 96 mole percent) of repeat units selected from the group consisting of type B, C, and G repeat units (i.e., the polymers should contain no more than about 10 mole percent (preferably no more than about 4 mole percent) of repeat units not selected from types B, C, and G).

The Class I polymers are easily converted to partial or fully saturated salts by a simple reaction with an appropriate salt-forming cation compound. Usable cations can be simple cations such as sodium, but more complex cations can also be used, such as cations containing a metal atom and other atom(s) as well, e.g., vanadyl cations. Among preferred metal cations are those derived from alkali, alkaline earth, and transition metals. The cations may also be amines (as used herein, “amines” refers to primary, secondary, or tertiary amines, monoamines, diamines, and triamines, as well as ammonia, ammonium ions, quaternary amines, quaternary ammonium ions, alkanolamines (e.g., ethanolamine, diethanolamine, and triethanolamine), and tetraalkylammonium species). The most preferred class of amines are alkyl amines, where the alkyl group(s) have from 1-30 carbon atoms and are of straight or branched chain configuration. Such amines should be essentially free of aromatic rings (no more than about 5 mole percent aromatic rings, and more preferably no more than about 1 mole percent thereof). A particularly suitable alkyl amine is isopropylamine. These possible secondary cations should be reacted with no more than about 10 mole percent of the repeat units of the polymer.

1. Type B Repeat Units

Type B repeat units are dicarboxylate repeat units derived from monomers of maleic acid and/or anhydride, fumaric acid and/or anhydride, mesaconic acid and/or anhydride, substituted maleic acid and/or anhydride, substituted fumaric acid and/or anhydride, substituted mesaconic acid and/or anhydride, mixtures of the foregoing, and any isomers, esters, acid chlorides, and partial or complete salts of any of the foregoing. As used herein with respect to the type B repeat units, “substituted” species refers to alkyl substituents (preferably C1-C6 straight or branched chain alkyl groups substantially free of ring structures), and halo substituents (i.e., no more than about 5 mole percent of either ring structures or halo substituents, preferably no more than about 1 mole percent of either); the substituents are normally bound to one of the carbons of a carbon-carbon double bond of the monomer(s) employed. In preferred forms, the total amount of type B repeat units in the Class I polymers of the invention should range from about 1-70 mole percent, more preferably from about 20-65 mole percent, and most preferably from about 35-55 mole percent, where the total amount of all of the repeat units in the Class I polymer is taken as 100 mole percent.

Maleic acid, methylmaleic acid, maleic anhydride, methylmaleic anhydride, and mesaconic acid (either alone or as various mixtures) are the most preferred monomers for generation of type B repeat units. Those skilled in the art will appreciate the usefulness of in situ conversion of acid anhydrides to acids in a reaction vessel just before or even during a reaction. However, it is also understood that when corresponding esters (e.g., maleic or citraconic esters) are used as monomers during the initial polymerization, this should be followed by hydrolysis (acid or base) of pendant ester groups to generate a final carboxylated polymer substantially free of ester groups.

2. Type C Repeat Units

Type C repeat units are derived from monomers of itaconic acid and/or anhydride, substituted itaconic acid and/or anhydride, as well as isomers, esters, acid chlorides, and partial or complete salts of any of the foregoing. The type C repeat units are present in the preferred Class I polymers of the invention at a level of from about 1-80 mole percent, more preferably from about 15-75 mole percent, and most preferably from about 20-55 mole percent, where the total amount of all of the repeat units in the polymer is taken as 100 mole percent.

The itaconic acid monomer used to form type C repeat unit has one carboxyl group, which is not directly attached to the unsaturated carbon-carbon double bond used in the polymerization of the monomer. Hence, the preferred type C repeat unit has one carboxyl group directly bound to the polymer backbone, and another carboxyl group spaced by a carbon atom from the polymer backbone. The definitions and discussion relating to “substituted,” “salt,” and useful salt-forming cations (metals, amines, and mixtures thereof) with respect to the type C repeat units, are the same as those set forth for the type B repeat units.

Unsubstituted itaconic acid and itaconic anhydride, either alone or in various mixtures, are the most preferred monomers for generation of type C repeat units. Again, if itaconic anhydride is used as a starting monomer, it is normally useful to convert the itaconic anhydride monomer to the acid form in a reaction vessel just before or even during the polymerization reaction. Any remaining ester groups in the polymer are normally hydrolyzed, so that the final carboxylated polymer is substantially free of ester groups.

3. Type G Repeat Units

Type G repeat units are derived from substituted or unsubstituted sulfonate-bearing monomers possessing at least one carbon-carbon double bond and at least one sulfonate group, in acid, partial or complete salt, or other form, and which are substantially free of aromatic rings and amide groups (i.e., no more than about 5 mole percent of either aromatic rings or amide groups, preferably no more than about 1 mole percent of either). The type G repeat units are preferably selected from the group consisting of C1-C8 straight or branched chain alkenyl sulfonates, substituted forms thereof, and any isomers or salts of any of the foregoing; especially preferred are alkenyl sulfonates selected from the group consisting of vinyl, allyl, and methallylsulfonic acids or salts. The total amount of type G repeat units in the Class I polymers of the invention should range from about 0.1-65 mole percent, more preferably from about 1-35 mole percent, and most preferably from about 1-25 mole percent, where the total amount of all of the repeat units in the Class I polymer is taken as 100 mole percent. The definitions and discussion relating to “substituted,” “salt,” and useful salt-forming cations (metals, amines, and mixtures thereof) with respect to the type G repeat units, are the same as those set forth for the type B repeat units.

Vinylsulfonic acid, allylsulfonic acid, and methallylsulfonic acid, either alone or in various mixtures, are deemed to be the most preferred monomers for generation of type G repeat units. It has also been found that alkali metal salts of these acids are also highly useful as monomers. In this connection, it was unexpectedly discovered that during polymerization reactions yielding the novel polymers of the invention, the presence of mixtures of alkali metal salts of these monomers with acid forms thereof does not inhibit completion of the polymerization reaction.

### Further Preferred Characteristics of the Class I Polymers

The total abundance of type B, C, and G repeat units in the Class I polymers of the invention is preferably at least about 90 mole percent, more preferably at least about 96 mole percent, and most preferably the polymers consist essentially of or are 100 mole percent B, C, and G-type repeat units. It will be understood that the relative amounts and identities of polymer repeat units can be varied, depending upon the specific properties desired in the resultant polymers. Moreover, it is preferred that the Class I polymers of the invention contain no more than about 10 mole percent of any of (i) non-carboxylate olefin repeat units, (ii) ether repeat units, (iii) ester repeat units, (iv) non-sulfonated monocarboxylic repeat units, and (v) amide-containing repeat units. “Non-carboxylate” and “non-sulfonated” refers to repeat units having essentially no carboxylate groups or sulfonate groups in the corresponding repeat units, namely less that about 55 by weight in the repeat units. Advantageously, the mole ratio of the type B and type C repeat units in combination to the type G repeat units (that is, the mole ratio of (B+C)/G) should be from about 0.5-20:1, more preferably from about 2:1-20:1, and still more preferably from about 2.5:1-10:1. Still further, the polymers should be essentially free (e.g., less than about 1 mole percent) of alkyloxylates or alkylene oxide (e.g., ethylene oxide)-containing repeat units, and most desirably entirely free thereof.

The preferred Class I polymers of the invention have the repeat units thereof randomly located along the polymer chain without any ordered sequence of repeat units. Thus, the polymers hereof are not, e.g., alternating with different repeat units in a defined sequence along the polymer chain.

It has also been determined that the preferred Class I polymers of the invention should have a very high percentage of the repeat units thereof bearing at least one anionic group, e.g., at least about 80 mole percent, more preferably at least about 90 mole percent, and most preferably at least about 95 mole percent. It will be appreciated that the B and C repeat units have two anionic groups per repeat unit, whereas the preferred sulfonate repeat units have one anionic group per repeat unit.

For a variety of applications, certain tetrapolymer compositions are preferred, i.e., a preferred polymer backbone composition range (by mole percent, using the parent monomer names of the corresponding repeat units) is: maleic acid 35-50%; itaconic acid 20-55%; methallylsulfonic acid 1-25%; and allylsulfonic acid 1-20%, where the total amount of all of the repeat units in the polymer is taken as 100 mole percent. It has also been found that even small amounts of repeat units, which are neither B nor C repeat units, can significantly impact the properties of the final polymers, as compared with prior BC polymers. Thus, even 1 mole percent of each of 2 different G repeat units can result in a tetrapolymer exhibiting drastically different behaviors, as compared with BC polymers.

The molecular weight of the polymers is also highly variable, again depending principally upon the desired properties. Generally, the molecular weight distribution for polymers in accordance with the invention is conveniently measured by size exclusion chromatography. Broadly, the molecular weight of the polymers ranges from about 800-50,000, and more preferably from about 1000-5000. For some applications, it is advantageous that at least 90% of the finished polymer be at or above a molecular weight of about 1000 measured by size exclusion chromatography in 0.1 M sodium nitrate solution via refractive index detection at 35° C. using polyethylene glycol standards. Of course, other techniques for such measurement can also be employed.

Especially preferred Class I polymers include the following repeat units: maleic—from about 30-55 mole percent, more preferably from about 40-50 mole percent, and most preferably about 45 mole percent; itaconic—from about 35-65 mole percent, more preferably from about 40-60 mole percent, and most preferably about 50 mole percent; methallylsulfonic—from about 1-7 mole percent, more preferably from about 3-6 mole percent, and most preferably about 4 mole percent; and allylsulfonic—from about 0.1-3 mole percent, more preferably from about 0.5-2 mole percent, and most preferably about 1 mole percent. This type of polymer is typically produced as a partial alkali metal salt (preferably sodium) at a pH of from about 0.2-3, more preferably from about 0.3-2, and most preferably about 1. The single most preferred polymer of this type is a partial sodium salt having a pH of about 1, with a repeat unit molar composition of maleic 45 mole percent, itaconic 50 mole percent, methallylsulfonic 4 mole percent, and allylsulfonic 1 mole percent. This specific polymer is referred to herein as the “T5” polymer.

### Syntheses of the Class I Polymers

Virtually any conventional method of free radical polymerization may be suitable for the synthesis of the Class I polymers of the invention. However, a preferred and novel synthesis may be used, which is applicable not only for the production of the Class I polymers of the invention, but also for the synthesis of polymers containing dicarboxylate repeat units and sulfonate repeat units and preferably containing at least one carbon-carbon double bond. Such types of polymers are disclosed in U.S. Pat. Nos. 5,536,311 and 5,210,163.

Generally speaking, the new synthesis methods comprise carrying out a free radical polymerization reaction between dicarboxylate and sulfonate repeat units in the presence of hydrogen peroxide and vanadium-containing species to achieve a conversion to polymer in excess of 90%, and more preferably in excess of 98%, by mole. That is, a dispersion of the dicarboxylate and sulfonated monomers is created and free radical initiator(s) are added followed by allowing the monomers to polymerize.

Preferably, the hydrogen peroxide is the sole initiator used in the reaction, but in any case, it is advantageous to conduct the reaction in the absence of any substantial quantities of other initiators (i.e., the total weight of the initiator molecules used should be about 95% by weight hydrogen peroxide, more preferably about 98% by weight, and most preferably 100% by weight thereof). Various sources of vanadium may be employed, with vanadium oxysulfates being preferred.

It has been discovered that it is most advantageous to perform these polymerization reactions in substantially aqueous dispersions (e.g., at least about 95% by weight water, more preferably at least about 98% by weight water, and most preferably 100% by weight water). The aqueous dispersions may also contain additional monomer, but only to the minor extent noted.

It has also been found that the preferred polymerization reactions may be carried out without the use of inert atmospheres, e.g., in an ambient air environment. As is well known in the art, free radical polymerization reactions in dispersions are normally conducted in a way that excludes the significant presence of oxygen. As a result, these prior techniques involve such necessary and laborious steps as degassing, inert gas blanketing of reactor contents, monomer treatments to prevent air from being present, and the like. These prior expedients add to the cost and complexity of the polymerizations, and can present safety hazards. However, in the polymerizations of the polymers of the present invention, no inert gas or other related steps are required, although they may be employed if desired.

One preferred embodiment comprises creating highly concentrated aqueous dispersions of solid monomer particles (including saturated dispersions containing undissolved monomers) at a temperature of from about 50-125° C., more preferably from about 75-110° C., and adding vanadium oxysulfate to give a vanadium concentration in the dispersion of from about 1-1000 ppm, and more preferably from about 5-500 ppm (metals basis). This is followed by the addition of hydrogen peroxide over a period of from about 30 minutes-24 hours (more preferably from about 1-5 hours) in an amount effective to achieve polymerization. This process is commonly carried out in a stirred tank reactor equipped with facilities for controlling temperature and composition, but any suitable equipment used for polymerization may be employed.

Another highly preferred and efficient embodiment involves charging a stirred tank reactor with water, followed by heating and the addition of monomers to give a dispersion having from about 40-75% w/w solids concentration. Where maleic and/or itaconic monomers are employed, they may be derived either from the corresponding acid monomers, or from in situ conversion of the anhydrides to acid in the water. Carboxylate and sulfonated monomers are preferred in their acid and/or anhydride form, although salts may be used as well. Surprisingly, it has been found that incomplete monomer dissolution is not severely detrimental to the polymerization; indeed, the initially undissolved fraction of monomers will dissolve at some time after polymerization has been initiated.

After the initial heating and introduction of monomers, the reactor contents are maintained at a temperature between about 80-125° C., with the subsequent addition of vanadium oxysulfate. Up to this point in the reaction protocol, the order of addition of materials is not critical. After introduction of vanadium oxysulfate, a hydrogen peroxide solution is added over time until substantially all of the monomers are converted to polymer. Peroxide addition may be done at a constant rate, a variable rate, and with or without pauses, at a fixed or variable temperature. The concentration of peroxide solution used is not highly critical, although the concentration on the low end should not dilute the reactor contents to the point where the reaction becomes excessively slow or impractically diluted. On the high end, the concentration should not cause difficulties in performing the polymerization safely in the equipment being used.

Preferably, the polymerization reactions of the invention are carried out to exclude substantial amounts of dissolved iron species (i.e., more than about 5% by weight of such species, and more preferably substantially less, on the order of below about 5 ppm, and most advantageously under about 1 ppm). This is distinct from certain prior techniques requiring the presence of iron-containing materials. Nonetheless, it is acceptable to carry out the polymerization of the invention in 304 or 316 stainless steel reactors. It is also preferred to exclude from the polymerization reaction any significant amounts (nor more than about 5% by weight) of the sulfate salts of ammonium, amine, alkali and alkaline earth metals, as well as their precursors and related sulfur-containing salts, such as bisulfites, sulfites, and metabisulfites. It has been found that use of these sulfate-related compounds leaves a relatively high amount of sulfates and the like in the final polymers, which either must be separated or left as a product contaminant.

The high polymerization efficiencies of the preferred syntheses result from the use of water as a solvent and without the need for other solvents, elimination of other initiators (e.g., azo, hydroperoxide, persulfate, organic peroxides) iron and sulfate ingredients, the lack of recycling loops, so that substantially all of the monomers are converted to the finished polymers in a single reactor. This is further augmented by the fact that the polymers are formed first, and subsequently, if desired, partial or complete salts can be created.

### EXAMPLES

The following examples describe preferred synthesis techniques for preparing polymers; it should be understood, however, that these examples are provided by way of illustration only and nothing therein should be taken as a limitation on the overall scope of the invention.

### Example 1

### Exemplary Synthesis

Apparatus:

A cylindrical reactor was used, capable of being heated and cooled, and equipped with efficient mechanical stirrer, condenser, gas outlet (open to atmosphere), solids charging port, liquids charging port, thermometer and peroxide feeding tube.

Procedure: Water was charged into the reactor, stirring was initiated along with heating to a target temperature of 95° C. During this phase, itaconic acid, sodium methallylsulfonate, sodium allylsulfonate, and maleic anhydride were added so as to make a 50% w/w solids dispersion with the following monomer mole fractions:
maleic: 45%
itaconic: 35%
methallylsulfonate: 15%
allylsulfonate: 5%
   When the reactor temperature reached 95° C., vanadium oxysulfate was added to give a vanadium metal concentration of 25 ppm by weight. After the vanadium salt fully dissolved, hydrogen peroxide (as 50% w/w dispersion) was added continuously over 3 hours, using the feeding tube. The total amount of hydrogen peroxide added was 5% of the dispersion weight in the reactor prior to peroxide addition. After the peroxide addition was complete, the reactor was held at 95° C. for two hours, followed by cooling to room temperature.

The resulting polymer dispersion was found to have less than 2% w/w total of residual monomers as determined by chromatographic analysis.

### Example 2

### Exemplary Synthesis

Apparatus:

Same as Example 1

Procedure: Water was charged into the reactor, stirring was initiated along with heating to a target temperature of 100° C. During this phase, itaconic acid, sodium methallylsulfonate, sodium allylsulfonate, and maleic anhydride were added so as to make a 70% w/w solids dispersion with the following monomer mole fractions:
maleic: 45%
itaconic: 50%
methallylsulfonate: 4%
allylsulfonate: 1%
   When the reactor temperature reached 100° C., vanadium oxysulfate was added to give a vanadium metal concentration of 25 ppm by weight. After the vanadium salt fully dissolved, hydrogen peroxide (as 50% w/w dispersion) was added continuously over 3 hours, using the feeding tube. The total amount of hydrogen peroxide added was 7.5% of the dispersion weight in the reactor prior to peroxide addition. After the peroxide addition was complete, the reactor was held at 100° C. for two hours, followed by cooling to room temperature.

The resulting polymer dispersion was found to have less than 1% w/w total of residual monomers as determined by chromatographic analysis.

### Example 3

### Preparation of Tetrapolymer Partial Salts

A tetrapolymer calcium sodium salt dispersion containing 40% by weight polymer solids in water was prepared by the preferred free radical polymerization synthesis of the invention, using an aqueous monomer reaction mixture having 45 mole percent maleic anhydride, 35 mole percent itaconic acid, 15 mole percent methallylsulfonate sodium salt, and 5 mole percent allylsulfonate. The final tetrapolymer dispersion had a pH of slightly below 1.0 and was a partial sodium salt owing to the sodium cation on the sulfonate monomers. At least about 90% of the monomers were polymerized in the reaction.

This sodium partial salt tetrapolymer was used to create 40% solids in water calcium salts. In each instance, apart from the sodium present in the tetrapolymer mixture, appropriate bases or base precursors (e.g., carbonates), or mixtures thereof were added to the aqueous tetrapolymer at room temperature to generate the corresponding salts. Specifically, the following basic reactants were employed with quantities of the tetrapolymer to give the following salts:

Salt A—calcium carbonate and a minor amount of sodium hydroxide, pH 1.5.

Salt B—calcium carbonate and a minor amount of sodium hydroxide, pH 3.5.

### Example 4

### Exemplary Synthesis

A terpolymer salt dispersion containing 70% by weight polymer solids in water was prepared using a cylindrical reactor capable of being heated and cooled, and equipped with an efficient mechanical stirrer, a condenser, a gas outlet open to the atmosphere, respective ports for charging liquids and solids to the reactor, a thermometer, and a peroxide feeding tube.

Water (300 g) was charged into the reactor with stirring and heating to a target temperature of 95° C. During heating, itaconic acid, sodium methallylsulfonate, and maleic anhydride were added so as to make a 75% w/w solids dispersion with the following monomer mole fractions: maleic anhydride—20%; itaconic acid—60%; methallylsulfonate sodium salt—20%. When the monomers were initially added, they were in suspension in the water. As the temperature rose, the monomers became more fully dissolved before polymerization was initiated, and the maleic anhydride was hydrolyzed to maleic acid. When the reactor temperature reached 95° C., vanadium oxysulfate was added to yield a vanadium metal concentration of 50 ppm by weight of the reactor contents at the time of addition of the vanadium salt. After the vanadium salt fully dissolved, hydrogen peroxide was added as a 50% w/w dispersion in water continuously over two hours. At the time of hydrogen peroxide addition, not all of the monomers were completely dissolved, achieving what is sometimes referred to as “slush polymerization”; the initially undissolved monomers were subsequently dissolved during the course of the reaction. The total amount of hydrogen peroxide added equaled 5% of the dispersion weight in the reactor before addition of the peroxide.

After the peroxide addition was completed, the reaction mixture was held at 95° C. for two hours, and then allowed to cool to room temperature. The resulting polymer dispersion had a pH of slightly below 1.0 and was a partial sodium salt owing to the sodium cation on the sulfonate monomers. The dispersion was found to have a monomer content of less than 2% w/w, calculated as a fraction of the total solids in the reaction mixture, as determined by chromatographic analysis. Accordingly, over 98% w/w of the initially added monomers were converted to polymer.

Further disclosure pertaining to the Class I polymers and uses thereof is set forth in application Ser. No. 62/001,110, filed May 21, 2014, which is fully incorporated by reference herein.

### Class IA Polymers

Class IA polymers contain both carboxylate and sulfonate functional groups, but are not the tetra- and higher order polymers of Class I. For example, terpolymers of maleic, itaconic, and allylsulfonic repeat units, which are per se known in the prior art, will function as the polyanionic polymer component of the compositions of the invention. The Class IA polymers thus are normally copolymers and terpolymers, advantageously including repeat units individually and independently selected from the group consisting of type B, type C, and type G repeat units, without the need for any additional repeat units. Such polymers can be synthesized in any known fashion, and can also be produced using the previously described Class I polymer synthesis.

Class IA polymers preferably have the same molecular weight ranges and the other specific parameters (e.g., pH and polymer solids loading) previously described in connection with the Class I polymers.

The Class IA polymers are easily converted to partial or fully saturated salts by a simple reaction with an appropriate salt-forming cation compound. Usable cations can be simple cations such as sodium, but more complex cations can also be used, such as cations containing a metal atom and other atom(s) as well, e.g., vanadyl cations. Among preferred metal cations are those derived from alkali, alkaline earth, and transition metals. The cations may also be amines (as used herein, “amines” refers to primary, secondary, or tertiary amines, monoamines, diamines, and triamines, as well as ammonia, ammonium ions, quaternary amines, quaternary ammonium ions, alkanolamines (e.g., ethanolamine, diethanolamine, and triethanolamine), and tetraalkylammonium species). The most preferred class of amines are alkyl amines, where the alkyl group(s) have from 1-30 carbon atoms and are of straight or branched chain configuration. Such amines should be essentially free of aromatic rings (no more than about 5 mole percent aromatic rings, and more preferably no more than about 1 mole percent thereof). A particularly suitable alkyl amine is isopropylamine. These possible secondary cations should be reacted with no more than about 10 mole percent of the repeat units of the polymer.

The total abundance of type B, C, and G repeat units in the Class IA polymers of the invention is preferably at least about 90 mole percent, more preferably at least about 96 mole percent, and most preferably the polymers consist essentially of or are 100 mole percent B, C, and G-type repeat units. It will be understood that the relative amounts and identities of polymer repeat units can be varied, depending upon the specific properties desired in the resultant polymers. Moreover, it is preferred that the Class IA polymers of the invention contain no more than about 10 mole percent of any of (i) non-carboxylate olefin repeat units, (ii) ether repeat units, (iii) ester repeat units, (iv) non-sulfonated monocarboxylic repeat units, and (v) amide-containing repeat units. “Non-carboxylate” and “non-sulfonated” refers to repeat units having essentially no carboxylate groups or sulfonate groups in the corresponding repeat units, namely less that about 55 by weight in the repeat units.

The preferred Class IA polymers of the invention have the repeat units thereof randomly located along the polymer chain without any ordered sequence of repeat units. Thus, the polymers hereof are not, e.g., alternating with different repeat units in a defined sequence along the polymer chain.

The preferred Class IA polymers of the invention should have a very high percentage of the repeat units thereof bearing at least one anionic group, e.g., at least about 80 mole percent, more preferably at least about 90 mole percent, and most preferably at least about 95 mole percent. It will be appreciated that the B and C repeat units have two anionic groups per repeat unit, whereas the preferred sulfonate repeat units have one anionic group per repeat unit.

The molecular weight of the polymers is also highly variable, again depending principally upon the desired properties. Generally, the molecular weight distribution for polymers in accordance with the invention is conveniently measured by size exclusion chromatography. Broadly, the molecular weight of the polymers ranges from about 800-50,000, and more preferably from about 1000-5000. For some applications, it is advantageous that at least 90% of the finished polymer be at or above a molecular weight of about 1000 measured by size exclusion chromatography in 0.1 M sodium nitrate solution via refractive index detection at 35° C. using polyethylene glycol standards. Of course, other techniques for such measurement can also be employed.

### Class II Polymers

Broadly speaking, the polyanionic polymers of this class are of the type disclosed in U.S. Pat. No. 8,043,995, which is incorporated by reference herein in its entirety. The polymers include repeat units derived from at least two different monomers individually and respectively taken from the group consisting of what have been denominated for ease of reference as B′ and C′ monomers; alternately, the polymers may be formed as homopolymers or copolymers from recurring C′ monomers. The repeat units may be randomly distributed throughout the polymer chains.

In detail, repeat unit B′ is of the general formula

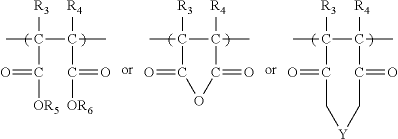

and repeat unit C′ is of the general formula

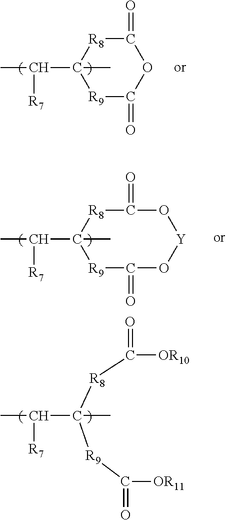

wherein each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc. up to C₃₀ based ester groups, R′CO₂ groups, OR′ groups and COOX groups, wherein R′ is selected from the group consisting of C₁-C₃₀ straight, branched chain and cyclic alkyl or aryl groups and X is selected from the group consisting of H, the alkali metals, NH₄ and the C₁-C₄ alkyl ammonium groups, R₃ and R₄ are individually and respectively selected from the group consisting of H, Cᵣ C₃₀ straight, branched chain and cyclic alkyl or aryl groups, R₅, R₆, R₁₀ and R₁₁ are individually and respectively selected from the group consisting of H, the alkali metals, NH₄ and the C₁-C₄ alkyl ammonium groups, Y is selected from the group consisting of Fe, Mn, Mg, Zn, Cu, Ni, Co, Mo, V, W, the alkali metals, the alkaline earth metals, polyatomic cations containing any of the foregoing (e.g., VO⁺²), amines, and mixtures thereof; and R₈ and R₉ are individually and respectively selected from the group consisting of nothing (i.e., the groups are non-existent), CH₂, C₂H₄, and C₃H₆.

As can be appreciated, the Class II polymers typically have different types and sequences of repeat units. For example, a Class II polymer comprising B′ and C′ repeat units may include all three forms of B′ repeat units and all three forms of C′ repeat units. However, for reasons of cost and ease of synthesis, the most useful Class II polymers are made up of B′ and C′ repeat units. In the case of the Class II polymers made up principally of B′ and C′ repeat units, R₅, R₆, R₁₀, and R₁₁ are individually and respectively selected from the group consisting of H, the alkali metals, NH₄, and the C₁-C₄ alkyl ammonium groups. This particular Class II polymer is sometimes referred to as a butanedioic methylenesuccinic acid copolymer and can include various salts and derivatives thereof.

The Class II polymers may have a wide range of repeat unit concentrations in the polymer. For example, Class II polymers having varying ratios of B′:C′ (e.g., 10:90, 60:40, 50:50 and even 0:100) are contemplated and embraced by the present invention. Such polymers would be produced by varying monomer amounts in the reaction mixture from which the final product is eventually produced and the B′ and C′ type repeat units may be arranged in the polymer backbone in random order or in an alternating pattern.

The Class II polymers may have a wide variety of molecular weights, ranging for example from 500-5,000,000, depending chiefly upon the desired end use. Additionally, n can range from about 1-10,000 and more preferably from about 1-5,000.

Preferred Class II polymers are usually synthesized using dicarboxylic acid monomers, as well as precursors and derivatives thereof. For example, polymers containing mono and dicarboxylic acid repeat units with vinyl ester repeat units and vinyl alcohol repeat units are contemplated; however, polymers principally comprised of dicarboxylic acid repeat units are preferred (e.g., at least about 85%, and more preferably at least about 93%, of the repeat units are of this character). Class II polymers may be readily complexed with salt-forming cations using conventional methods and reactants.

### Synthesis of the Class II Polymers of the Invention

In general, the Class II polymers are made by free radical polymerization serving to convert selected monomers into the desired polymers with repeat units. Such polymers may be further modified to impart particular structures and/or properties. A variety of techniques can be used for generating free radicals, such as addition of peroxides, hydroperoxides, azo initiators, persulfates, percarbonates, per-acid, charge transfer complexes, irradiation (e.g., UV, electron beam, X-ray, gamma-radiation and other ionizing radiation types), and combinations of these techniques. Of course, an extensive variety of methods and techniques are well known in the art of polymer chemistry for initiating free-radical polymerizations. Those enumerated herein are but some of the more frequently used methods and techniques. Any suitable technique for performing free-radical polymerization is likely to be useful for the purposes of practicing the present invention.

The polymerization reactions are carried out in a compatible solvent system, namely a system which does not unduly interfere with the desired polymerization, using essentially any desired monomer concentrations. A number of suitable aqueous or non-aqueous solvent systems can be employed, such as ketones, alcohols, esters, ethers, aromatic solvents, water and mixtures thereof. Water alone and the lower (C₁-C₄) ketones and alcohols are especially preferred, and these may be mixed with water if desired. In some instances, the polymerization reactions are carried out with the substantial exclusion of oxygen, and most usually under an inert gas such as nitrogen or argon. There is no particular criticality in the type of equipment used in the synthesis of the polymers, i.e., stirred tank reactors, continuous stirred tank reactors, plug flow reactors, tube reactors and any combination of the foregoing arranged in series may be employed. A wide range of suitable reaction arrangements are well known to the art of polymerization.

In general, the initial polymerization step is carried out at a temperature of from about 0° C. to about 120° C. (more preferably from about 30° C. to about 95° C. for a period of from about 0.25 hours to about 24 hours and even more preferably from about 0.25 hours to about 5 hours). Usually, the reaction is carried out with continuous stirring.

After the polymerization reaction is complete, the Class II polymers may be converted to partial or saturated salts using conventional techniques and reactants.

### Preferred Class II Maleic-Itaconic Polymers

The most preferred Class II polymers are composed of maleic and itaconic B′ and C′ repeat units and have the generalized formula

where X is either H or another salt-forming cation, depending upon the level of salt formation.

In a specific example of the synthesis of a maleic-itaconic Class II polymer, acetone (803 g), maleic anhydride (140 g), itaconic acid (185 g) and benzoyl peroxide (11 g) were stirred together under inert gas in a reactor. The reactor provided included a suitably sized cylindrical jacketed glass reactor with mechanical agitator, a contents temperature measurement device in contact with the contents of the reactor, an inert gas inlet, and a removable reflux condenser. This mixture was heated by circulating heated oil in the reactor jacket and stirred vigorously at an internal temperature of about 65-70° C. This reaction was carried out over a period of about 5 hours. At this point, the contents of the reaction vessel were poured into 300 g water with

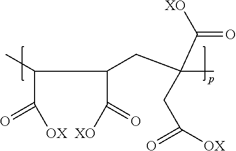

vigorous mixing. This gave a clear solution. The solution was subjected to distillation at reduced pressure to drive off excess solvent and water. After sufficient solvent and water have been removed, the solid product of the reaction precipitates from the concentrated solution, and is recovered. The solids are subsequently dried in vacuo. A schematic representation of this reaction is shown below.

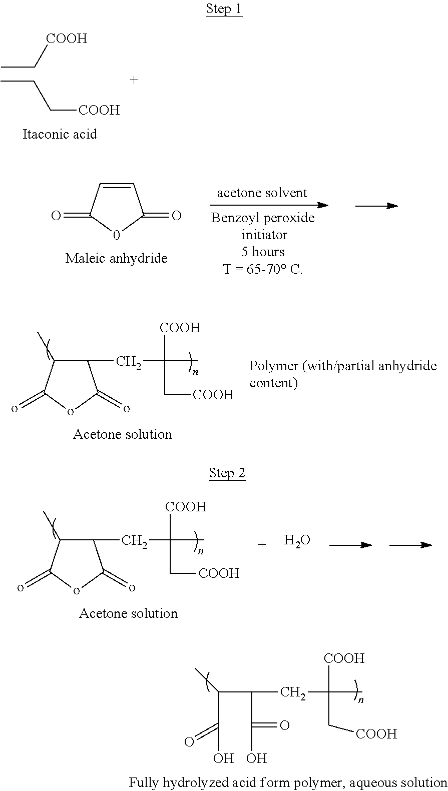

Once again, the Class II polymers should have the same preferred characteristics as those of the Class I and Class IA polymers set forth above.

### The Plant Growth Regulator/Polymer Compositions of the Invention

The liquid compositions in accordance with the invention at a minimum include respective quantities of plant growth regulator(s) and anionic polymer(s), but may also include other ingredients, such as fertilizers, micronutrients, or other plant treatment products. The compositions preferably do not have any significant amounts of amine oxides, i.e., less than about 0.05% by weight thereof, and preferably essentially no amine oxides. Normally, these liquid compositions substantially exclude those substances which are outside of the definition of “plant growth regulators” set forth above (i.e., no more than about 5% by volume of such non-plant growth regulator substances, and most preferably they are entirely absent). The liquid compositions may be initially formulated as aqueous concentrates which are then diluted with additional water to give use compositions.

The concentrates would typically contain from about 1-15% by volume polymer, more preferably from about 1.5-10% by volume, based upon the total volume of the liquid concentrate taken as 100% by volume. The amount of plant growth regulator(s) in the concentrates should range from about 300-6000 ppm, more preferably from about 750-3000 ppm. The water content of the concentrates should be from about 85-99% by volume, more preferably from about 90-98.5% by volume, where the total volume of the liquid concentrate is taken as 100% by volume. The pH of the concentrate compositions are typically acidic, and should range from about 0.5-6.5, more preferably from about 1.5-5.

The diluted liquid use compositions of the invention normally include from about 0.01-5% by volume polymer, more preferably from about 0.05-2% by volume, and most preferably from about 0.25-1% by volume, where the total volume of the liquid use composition is taken as 100% by volume. The amount of plant growth regulator(s) in the use compositions should range from about 100-2000 ppm, more preferably from about 250-1000 ppm. The water content of the use compositions should be from about 95-99.75% by volume, more preferably from about 99-99.75% by volume, where the total volume of the use composition is taken as 100% by volume. The pH of the use compositions should be correlated with the plant growth regulator(s) used in the compositions, so as to maintain pH levels which facilitate the operation of the regulator(s); generally these pH levels are acidic and typically range from about 0.5-6.5, more preferably from about 1.5-5.

Accordingly, from a generic perspective and embracing both concentrate and use compositions, the compositions contain from about 0.01-15% by volume polymer, and more preferably from about 0.05-10% by volume polymer. The amount of plant growth regulator(s) ranges from about 100-6000 ppm, and more preferably from about 250-3000 ppm. The water content of the compositions ranges from about 85-99.75% by volume, and more preferably from about 90-99.75% by volume. The pH levels are acidic and typically range from about 0.5-6.5, more preferably from about 1.5-5.

Generally, these liquid compositions, either as concentrates or as diluted use compositions, are simple mixtures containing the desired ingredients, such as dispersions, suspensions, colloids, or true solutions. In some embodiments, there is no classical ionic or covalent chemical bonding between the polymers and the plant growth regulator(s), although there may be some measure of electrostatic interaction between these components. The liquid use compositions are typically applied as dips, drenches, or sprays in greenhouse uses, and as broadcast sprays (both foliar and non-foliar), in-furrow, and sideband applications with field crops or seeds.

As noted above, final use compositions may include other plant growth aids, especially liquid fertilizers such as ammonium polyphosphate, UAN, and micronutrients which may be added to liquid formulations. These optional ingredients may be used singly or in any desired combination or mixture.

### EXAMPLES

### Example 5

In this Example, two series of field corn yield studies were undertaken using the following test compositions:
1. 5 gallons 10-34 APP+1 quart 9.0% Zinc Chelate
2. 5 gallons 10-34 APP+1 quart 9.0% Zinc Chelate+0.5% (v/v) AVAIL®
3. 5 gallons 10-34 APP+1 quart 9.0% Zinc Chelate+6 fluid ounces ASCEND®
4. 5 gallons 10-34 APP+1 quart 9.0% Zinc Chelate+6 fluid ounces ASCEND®+0.5% (v/v) AVAIL®

10-34 APP is standard ammonium polyphosphate liquid fertilizer. AVAIL® is a polymeric product for use with liquid fertilizers (CAS #701908-99-8) commercialized by Specialty Fertilizer Products, LLC of Leawood, Kans. The product is a partial ammonium salt of a maleic-itaconic copolymer containing substantially equimolar amounts of maleic and itaconic repeat units. The product is an aqueous mixture containing approximately 40% solids and has a pH of about 2, and is more fully described in an MSDS covering the product, which is incorporated by reference herein in its entirety. Accordingly, the maleic-itaconic copolymer partial ammonium salt was present at a level of about 0.2% by volume. ASCEND® is a commercially available plant growth regulator sold by Winfield Solutions, LLC, St. Paul, Minn., and has the following makeup:

| ACTIVE INGREDIENTS | |
|---|---|
| Cytokinin, as Kinetin | 0.090% |
| Gibberellic Acid | 0.030% |
| Indole Butyric Acid | 0.045% |
| OTHER INGREDIENTS | 99.835% |
| TOTAL | 100.000% |

The corresponding MSDS covering this product is incorporated by reference herein in its entirety.

In both of the series of tests, the fertility program included adequate nitrogen, phosphorus (50 lbs of additional phosphorus per acre), a minimum of 100 lbs per acre of potassium, and 30 lbs of ammonium sulfate per acre. Six replications of plot sizes (4-6 rows, 30-40 feet in length) were planted with minimum tillage.

Yield and nutrient uptake at growth stage V6 was completed for all trials, and the following results are averages of the six replications.

Wisconsin Tests

| | Grain Yield | V-6 Tissue Analysis (Percent) | | | | |
|---|---|---|---|---|---|---|
| | Bushels per Acre | Nitrogen | Phosphorus | Potassium | Sulfur | Zinc |
| 10-34 | 265.7 | 3.27 | 0.40 | 2.46 | 0.24 | 22.2 |
| 10-34 + Zn | 271.8 | 3.41 | 0.40 | 2.49 | 0.23 | 26.0 |
| 10-34 + Zn + MIC | 276.4 | 3.43 | 0.40 | 2.62 | 0.24 | 25.7 |
| 10-34 + Zn + PGRs | 273.6 | 3.42 | 0.40 | 2.56 | 0.24 | 25.5 |
| 10-34 + Zn + MIC + PGRs | 281.7 | 3.44 | 0.41 | 2.57 | 0.24 | 26.3 |
| p > f | 0.02 | 0.001 | 0.45 | 0.01 | 0.97 | 0.001 |
| LSD (0.10) | 7.7 | 0.03 | | 0.08 | | 1.49 |

Ohio Tests

| | | V-6 Tissue Analysis (Percent) | | | |
|---|---|---|---|---|---|
| | Grain Yield | | Phos- | | |
| | Bushels per | Phos- | phorus | | Zinc |
| | Acre | phorus | Uptake | Zinc | Uptake |
| 10-34 + Zn | 208.1 | 0.265 | 319 | 33.8 | 4066 |
| 10-34 + Zn + MIC | 213.3 | 0.254 | 266 | 30.8 | 3225 |
| 10-34 + Zn + PGRs | 210.2 | 0.262 | 338 | 32.0 | 4238 |
| 10-34 + Zn + | 218.1 | 0.260 | 294 | 33.4 | 3774 |
| MIC + PGRs | | | | | |
| p > f | | | | | |
| LSD (0.10) | | | | | |

### DISCUSSION

At both locations, the results were nearly identical. The results confirmed that the use of AVAIL® added 4.90 bushels per acre when used as a supplement to the APP/zinc chelate starter, and that ASCEND® gave a yield increase of 1.95 bushels. Therefore, the use of these products together should result in an increase of about 6.85 bushels per acre. However, the test results gave an increase of 9.95 bushels per acre, a much higher increase than expected. This established the synergistic effect of the use of AVAIL® and ASCEND® together. This phenomenon was further confirmed by a comparison of V6 nutrient uptake levels, which remained consistent between the tests.

### Example 6

In this test, soybean seedlings at true leaf emergence were sprayed with a series of aqueous test solutions at a rate of 20 gallons per acre. In those solutions including AVAIL®, use was made of AVAIL® for liquid phosphate fertilizers. The beans were then harvested one week later and were counted, dried, and weighed, and average weight per plant was determined. The treatment and test results are set forth below.

| | Plant | Total | Mean Plant |
|---|---|---|---|
| Treatment | Count | Dry Wt. (g) | Dry Wt. (g) |
| Control (no PGR) | 11 | 16.35 | 1.486 |
| 50 ppm gibberellic acid | 11 | 17.53 | 1.594 |
| 50 ppm gibberellic acid + | 9 | 15.33 | 1.703 |
| 0.5% (v/v) AVAIL ® | | | |
| 100 ppm gibberellic acid | 10 | 18.08 | 1.808 |
| 100 ppm gibberellic acid + | 11 | 20.61 | 1.874 |
| 0.5% (v/v) AVAIL ® | | | |
| 250 ppm gibberellic acid | 12 | 20.61 | 1.718 |
| 250 ppm gibberellic acid + | 12 | 23.54 | 1.962 |
| 0.5% (v/v) AVAIL ® | | | |
| 500 ppm gibberellic acid | 10 | 22.80 | 2.280 |
| 500 ppm gibberellic acid + | 9 | 21.67 | 2.408 |
| 0.5% (v/v) AVAIL ® | | | |

As is evident from the foregoing data, as the gibberellic acid concentration increased, the mean plant dry weight also increased. Moreover, the addition of the AVAIL® polymer (described in Example 5) caused an additional dry weight increase, as compared with the use of gibberellic acid alone.

### Example 7

In this series of tests, field trials were conducted at two different locations (Finley, N D and Whitewater, Wis.) using four different corn varieties at each location. In each study, there were six experimental treatments, replicated six times. The experimental treatments were added to the liquid fertilizer at the time of application. 10-34-0 liquid fertilizer was used in WI, whereas 6-24-6 liquid fertilizer was used in ND, with an application rate of 5 gallons per acre.

The Control test contained no polymer or PGR. AVAIL®, described in Example 5, was used at a level of 0.5% (v/v) based upon the liquid fertilizer used. ASCEND, likewise described in Example 5, was used at a level of 6 ounces per acre. The Experimental PGR product (Exp. PGR) was an aqueous maleic-itaconic copolymer having a solids content of 40-50% and a pH of 5.3 with added, unreacted PGRs. The copolymer was a partial salt of several micronutrients, namely zinc (1.3% w/w), manganese (0.7% w/w), copper (133 ppm), and calcium (750 ppm). The PGRs were Kinetin (600 ppm), Indolebutyric acid (300 ppm), and gibberellic acid (200 ppm).

The average yields for the replications are set forth below as Bu/Acre.

| | | | | ASCEND + | Exp. | Exp. PGR + |
|---|---|---|---|---|---|---|
| State/Variety | Control | AVAIL ® | ASCEND | AVAIL ® | PGR | AVAIL ® |
| WI/DKC 49-29 | 219.6 | 220.6 | 223.3 | 225.8 | 224.4 | 227.2 |
| WI/DKC 53-58 | 195.6 | 201.3 | 204.2 | 207.0 | 201.6 | 207.4 |
| WI/P00062 | 239.8 | 242.1 | 241.8 | 244.3 | 254.0 | 248.5 |
| WI/P0448R | 228.6 | 228.9 | 235.9 | 239.3 | 239.7 | 241.8 |
| ND/DK 31-10 | 123.4 | 121.4 | 121.3 | 126.7 | 123.1 | 126.9 |
| ND/T8210R | 129.8 | 134.6 | 135.9 | 136.4 | 139.5 | 141.7 |
| ND/P8640AM | 136.2 | 141.3 | 132.1 | 141.7 | 137.3 | 142.7 |
| ND/P86773AM | 143.6 | 145.8 | 141.5 | 146.4 | 141.2 | 149.3 |

As is evident from the foregoing data, in each instance, the use of polymer with the PGRs increased yields, as compared with the polymer alone and the PGRs alone.

I claim:

1. A composition comprising an aqueous mixture of a plant growth regulator and a polyanionic polymer, said polymer containing at least about 80 mol percent of repeat units bearing at least one anionic functional group, said plant growth regulator being present at a level of up to about 6000 ppm, and said composition having from about 85-99.75% by volume water.

2. The composition of claim 1, said plant growth regulator selected from the group consisting of antiauxins, auxins, cytokinins, defoliants, ethylene inhibitors, ethylene releasers, gametocides, gibberellins, growth inhibitors, growth retardants, growth stimulators, unclassified growth regulators, and mixtures thereof.

3. The composition of claim 1, said plant growth regulator comprising a plurality of different plant growth regulators.

4. The composition of claim 1, said polyanionic polymer including respective amounts of maleic and itaconic repeat units.

5. The composition of claim 4, said polymer comprising at least four repeat units distributed along the length of the polymer chain, said repeat units including at least one each of a maleic, itaconic, and sulfonate repeat unit.

6. The composition of claim 4, said polymer containing at least about 93% by weight of maleic and itaconic repeat units.

7. The composition of claim 6, said polymer consisting essentially of maleic and itaconic repeat units.

8. The composition of claim 4, said polymer including sulfonate repeat units.

9. The composition of claim 8, said polymer having from about 1-25% by weight of said sulfonate repeat units.

10. The composition of claim 9, said polymer having from about 1-70 mol percent of dicarboxylate repeat units derived from monomers of maleic acid and/or anhydride, humeric acid and/or anhydride, mesaconic acid and/or anhydride, from about 1-80 mol percent repeat units derived from itaconic acid and/or anhydride, and from about 1-65 mol percent of sulfonate repeat units possessing at least one carbon-carbon double bond and at least one sulfonate group.

11. The composition of claim 1, said composition further including a fertilizer.

12. The composition of claim 1, said composition being a dilutable concentrate and containing from about 1-15% by volume of said polymer.

13. The composition of claim 12, including from about 300-6000 ppm of said plant growth regulator.

14. The composition of claim 1, said composition being a use composition containing from about 0.1-5% by volume of said polymer.

15. The composition of claim 14, including from about 100-3000 ppm of said plant growth regulator.

16. A method of regulating plant growth comprising the step of applying a composition in accordance with claim 1 to a plant seed, a growing plant, or to soil adjacent a planted seed or growing plant.

17. A seed product comprising a plant seed in localized contact with a composition in accordance with claim 1.
